(19) United States
(12) Patent Application Publication
(10) Pub. No.: US 2025/0187153 A1
(43) Pub. Date: Jun. 12, 2025

(54) Quick Adjust Wrench

(71) Applicant: Charles Rubio, Riverside, CA (US)

(72) Inventor: Charles Rubio, Riverside, CA (US)

(21) Appl. No.: 18/383,431

(22) Filed: Oct. 24, 2023

(51) Int. Cl. B25B 13/50

(52) U.S. Cl. CPC B25B 13/5058

(57) ABSTRACT

Improvements in a pipe wrench that used a quick adjustment mechanism to secure and release the position of the moving jaw. With the quick adjust wrench the operator can release the locking teeth, slide the adjustable jaw, and release the locking teeth to lock the position of the moving jaw. The locking teeth move in a linear position towards or away from the moving jaw post. The operator can pull the locking mechanism, push the locking mechanism, or pinch the locking mechanism to lift the teeth out of engagement. The wrench uses magnetic forces to ensure that the teeth are engaged when the slider is released. The use of a magnet ensures that the movable jaw is normally locked in position unless an operator is physically displacing the locking mechanism.

### CROSS-REFERENCE TO RELATED APPLICATIONS

This application claims the benefit of Provisional Application Ser. No. 63/428,208 filed Nov. 28, 2022, the entire contents of which are hereby expressly incorporated by reference herein.

### PRIOR ART

U.S. Pat. No. 1,990,137 issued on Feb. 5, 1935, to N. J. Schrubb and is titled Wrench. This patent discloses a wrench that provides a slidable outer jaw type of wrench wherein the outer jaw is spring projected, and the adjusting nut therefore is released from connection therewith. While the nut can be displaced to adjust the jaw, spring forces push the nut outward of the handle.

U.S. Pat. No. 4,309,924 issued on Jan. 12, 1982, to Donald E. McLain and is titled Nut and Retainer for Quick Adjustable Jaw Wrench. This patent discloses an adjustable locking assembly for a pipe wrench structured and arranged to provide a modified nut assembly and locking assembly. While the jaw can be quickly moved, it requires rotating the nut to an open area between the nut threads.

U.S. Pat. No. 7,040,199 issued on May 9, 2006, to N. Scott Gregory and is titled Pipe Wrench Retrofit. This patent discloses a pipe wrench includes a head having a first aperture defining a central axis. The pipe wrench includes a first jaw coupled to the head having a plurality of teeth defining a first contact region, and a second jaw partially extending through the aperture of the head having a threaded portion and a plurality of teeth defining a second contact region. The second contact region extends beyond the first contact region in a direction parallel to side surfaces of the head. The pipe wrench includes a biasing mechanism located within the first aperture to align the threaded portion of the second jaw with the central axis of the first aperture, and an actuator having threads engaged with the threaded portion of the second jaw such that rotation of the actuator moves the second contact region of the second jaw relative to the first contact region of the first jaw. While the aperture in the nut can be opened to quickly slide the jaw, it still requires rotating the nut.

U.S. Pat. No. 11,247,313 issued on Feb. 15, 2022, to Michael St. Laurent and is titled Quick Adjust Pipe Wrench. This patent discloses an adjustable locking assembly for a pipe wrench structured and arranged to provide a modified nut assembly and locking assembly. The assembly requires rotting the nut to align or offset the nut threads with the teeth in the jaw.

What is needed is a quick adjust wrench that uses magnets to engage into the teeth with a linear displacement. The proposed quick adjust wrench disclosed in this document provides the solution.

### BACKGROUND OF THE INVENTION

A wrench is a common hand tool. One version of the wrench is a pipe wrench that has a nut that is rotated to open and close the distance between the jaws of the wrench. A pipe wrench is commonly used on a round pipe and as the handle of the wrench is rotated around the pipe the jaws of the wrench will grab into the pipe. A nut within the handle is turned and drives a screw secured to one of the jaws. Turning the nut moves one of the jaws. The jaw is moved a limited amount for each turn of the nut. If a large displacement of the jaw is required, it could take many turns to adjust from one jaw setting to another.

### SUMMARY OF THE INVENTION

It is an object of the quick adjust wrench to provide a pipe wrench where the distance between the jaws can be quickly adjusted. The time to adjust the distance between the jaws can take a considerable amount of time, especially when the wrench is used for a variety of different diameter pipes at the same location. Often pipes can branch from a large supply line to multiple smaller branch lines from a manifold. The operator must frequently adjust the jaw gap as they transition from the supply pipe to branch lines. With the quick adjust wrench the operator can release the locking teeth, slide the adjustable jaw, and release the locking teeth to lock the position of the moving jaw.

It is an object of the quick adjust wrench to use a linear movement of the engaging teeth to fit into the rod of the jaw. The locking teeth move in a linear position towards or away from the moving jaw post. This makes a simpler mechanism as opposed to trying to turn a nut, especially when the user is wearing gloves or is in a wet environment. The operator can pull the locking mechanism, push the locking mechanism, or pinch the locking mechanism to lift the teeth out of engagement.

It is another object of the quick adjust wrench to use magnetic forces to ensure that the teeth are engaged when the slider is released. The use of a magnet ensures that the movable jaw is normally locked in position unless an operator is physically displacing the locking mechanism. The magnetic force attracts the retaining mechanism. In some instances, the locking mechanism can be placed onto an existing pipe wrench where the fixed wrench body is constructed from magnetic material.

It is still another object of the quick adjust wrench for the magnet to be in either the handle or the moving jaw. In some pipe wrenches the wrench handle or body is constructed in a non-ferrous material the magnet can be inserted into a recess in the handle or the moving bar. A complimentary ferrous material or strip can be placed in the opposing side of the pipe wrench to force the attraction of the locking mechanism that prevents the wrench from opening or changing the position of the moving jaw. Using this positive locking mechanism to fix the position of the jaw a finer pitch of the teeth can be used to provide fine resolution along with using one-way teeth to allow an operator to slide the moving jaw into position without requiring manual displacement of the locking mechanism.

Various objects, features, aspects, and advantages of the present invention will become more apparent from the following detailed description of preferred embodiments of the invention, along with the accompanying drawings in which like numerals represent like components.

### BRIEF DESCRIPTION OF DRAWINGS

FIG. 1 shows a perspective view of a prior art pipe wrench with a replacement lock.

FIG. 2 shows a perspective view of the head of the adjustable pipe wrench in a preferred embodiment.

FIG. 3 shows an exploded view of the adjustable pipe wrench.

FIG. 4 shows a cross-sectional view of a preferred embodiment of the adjustable wrench.

FIG. 5 shows a cross-sectional view of a second preferred embodiment of the adjustable wrench.

### DETAILED DESCRIPTION OF THE INVENTION

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention but is merely representative of various embodiments of the invention. The illustrated embodiments of the invention will be best understood by reference to the drawings, wherein like parts are designated by like numerals throughout.

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated. The terminology used herein is for the purpose of describing particular embodiments only and is not intended to be limiting of the technology. As used herein, the singular forms “a,” “an,” and “the” are intended to include the plural forms as well, unless the context clearly indicates otherwise.

It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof. It will be understood that like or analogous elements and/or components, referred to herein, may be identified throughout the drawings with like reference characters.

Item Numbers and Description

| | |
|---|---|
| 10 wrench | 11 wrench |
| 20 fixed body | 21 handle |
| 22 side support | 23 slide clearance |
| 24 body | 25 opening |
| 26 opening | 27 handle opening |
| 28 recess | 30 lower jaw |
| 31 pin | 32 teeth |
| 50 movable jaw | 51 slide |
| 52 head | 53 upper jaw |
| 54 recess | 55 back teeth |
| 56 smooth | 57 bottom |
| 58 front teeth | 60 saw teeth |
| 61 smooth side | 80 slide keeper |
| 81 slide body | 82 tooth |
| 83 opening | 84 grip |
| 85 magnet | 86 gap |
| 87 teeth | 89 nut |
| 90 opening | 96 out |
| 97 down | 98 extend |
| 99 pull | |

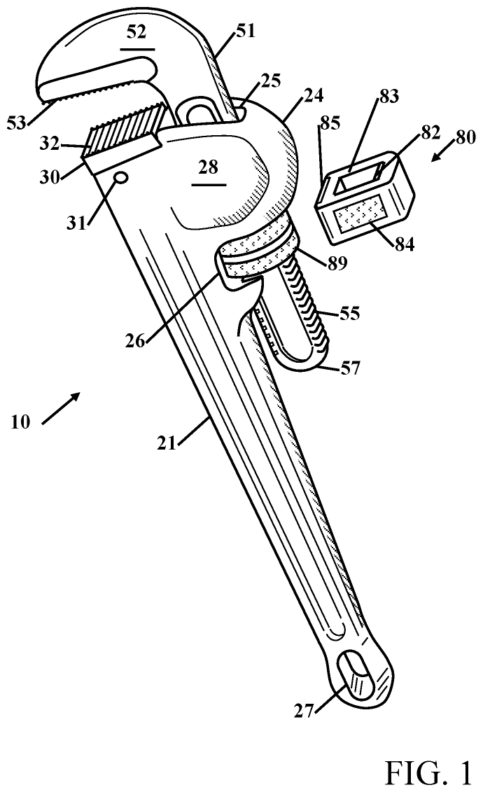

FIG. 1 shows a perspective view of a prior art pipe wrench 10 with a replacement slide keeper 80 lock. In some embodiments the bottom of the wrench body handle 21 can have a handle opening 27 or hole for hanging the wrench 10. This is a typical prior art pipe wrench 10 that can be updated to be a pipe wrench as described in this document. The major requirement for this update is that handle 21 of the wrench 10 needs to be made from a ferrous/metal or have sufficient iron for attraction by a magnet 85. The wrench 10 in this figure has a wrench body handle 21 with a lower jaw 30. The lower jaw 30 has gripping teeth 32 that are configured to grasp a pipe or nut. In some embodiments the lower jaw 30 can be replaceable by removing a pin 31 and installing a replacement lower jaw 30.

On the opposing side of the lower jaw 30 there is an opening 25 in the body 24 of the wrench 10 where a slide 51 can pass through the wrench 10. Some embodiments have a recess 28 that makes gripping the wrench 10 easier. The slide 51 has a head 52 with an upper jaw 53 that also has teeth for gripping an opposing side of a pipe or nut (not shown). The elongated length of the slide has a series of back teeth 55 or threads that operate with threads in a nut 89 to move the slide within the opening 25. Turning the nut 89 allows for moving the upper jaw 53 towards and away from the lower jaw 30. At the bottom 57 of slide 51 is rounded or squared and slide 51 can be completely unscrewed from the bottom 57 of the teeth 55 to remove or replace the slide 51.

The nut 89 sits in an opening 26 under the body 24 that operates to maintain a position of the nut 89 relative to the slide 51. To upgrade this wrench 10 to be a quick adjusting wrench the nut 26 is turned to completely remove the slide 51. Once the slide is removed the nut 89 can be discarded and the slide keeper 80 is placed in the original location of the nut 89. The slide 51 is then passed through the opening 25 and through an opening 83 in the slide. A magnet 85 in the slide keeper 80 will pull the slide keeper 80 towards the wrench body handle 21 to engage teeth 82 in the side keeper 80 into the back teeth 55 to maintain the position of the upper jaw 53 relative to the position of the lower jaw 30. To reposition the upper jaw 53 a user can grip 84 the sides of the slide keeper 80 and pull back the slide keeper 80 to disengage the teeth 82 of the slide keeper 80 from the back teeth 55. Slide 51 can then position of the upper jaw 53 quickly. Releasing the slide keeper 80 will allow the magnet 85 to again pull the slide keeper 80 towards the handle 21 and lock the teeth 82 into the back teeth 55 to fix the relative position of the upper jaw 53 to the lower jaw 30.

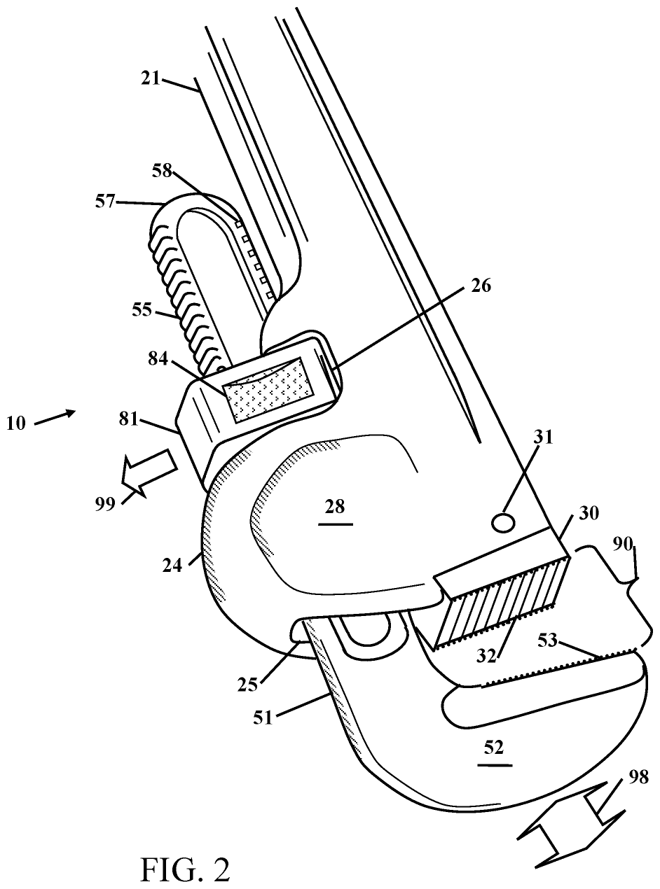

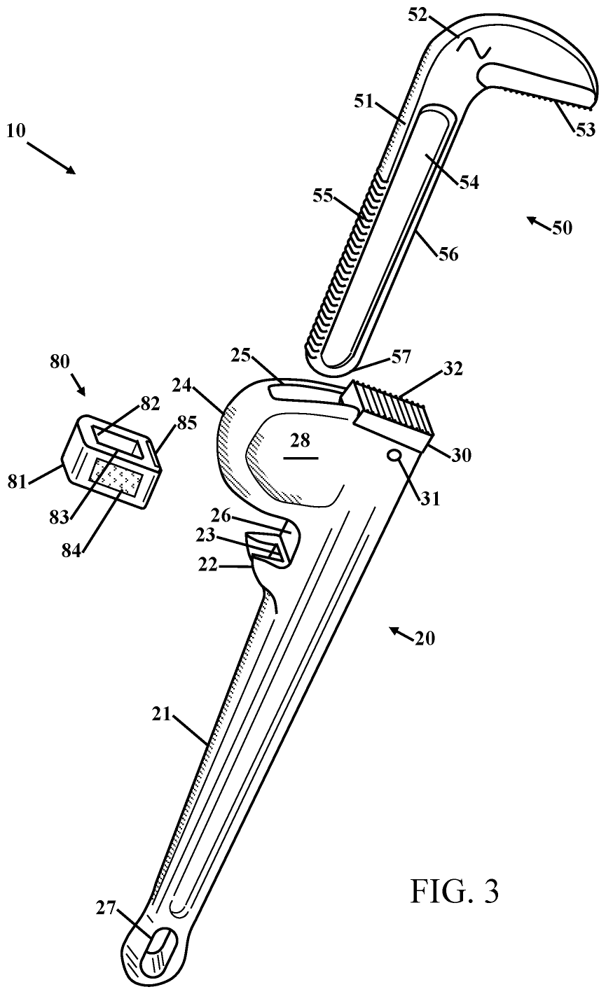

FIG. 2 shows a perspective view of the head of the adjustable pipe wrench 10 in a preferred embodiment with the slide body 81 around the slide 51 and FIG. 3 shows an exploded view of the adjustable pipe wrench 10. In some embodiments the lower jaw 30 can be replaceable by removing pin 31 to change the teeth 32 or to use a jaw that is smooth. Depending on the material used in the fixed body 20 magnet 85 can be incorporated in the slide keeper 80, the fixed body 20 or both parts. If the fixed body 20 is a non-ferrous material the magnet would need to be set or embedded in the bottom of the opening 26.

To adjust the opening 90 distance between the upper jaw 53 in the head 52 and the lower jaw 30 in the wrench body handle 21, a user would grip the 84 sides of the slide body 81 and pull 99 the slide keeper 80. The opening 90 is typically zero to 6 inches but could be greater than 6 inches. The opening 90 is adjusted to accept a pipe or a nut. This would dislodge the teeth 82 in the central opening 83 in the slide keeper 80 from the back teeth 55 of the slide 51 and allow for free movement of the movable jaw and the movable jaw can be extended 98 from or pushed into the body of the fixed body 20 through the opening 25. In some embodiments there is a gripping recess 28 in the body 24 of the handle where the slide 51 passes. The sides of slide 51 can have recess(es) 54. Releasing the slide keeper 80 allows the magnet 85 to pull the slide keeper 80 towards the back of the opening 26 in the handle 21 and engages the teeth 82 in the slide keeper 80 to lock into back teeth 55 on the slide 51 to prevent movement of the movable jaw 50 relative to the fixed body 20. The teeth 82 can be angled to match the pitch of the back teeth 55.

There is slide clearance 23 that provides a bearing surface for slide 51. At the sides of the slide clearance 23 are side supports 22 that help guide the slide 51 and provides locating features for holding and maintaining the position of the slide keeper.

While a series of front teeth 58 are shown in FIG. 2, they serve no function with movement of the movable jaw 50 or retraining movement of the movable jaw 50. FIG. 3 shows that the front of the movable jaw is smooth 56. At the bottom 57 of slide 51 is rounded or squared and slide 51 can be completely unscrewed from the bottom 57 of the teeth 55 to remove or replace the slide 51. In some embodiments the bottom of the handle 21 can have a handle opening 27 or hole for hanging the wrench 10. The shape if the teeth can be square, ACME or sawtooth to allow a person to push the upper jaw towards the lower jaw to overcome the magnetic attraction to quickly adjust and lock the position of the upper jaw to the lower jaw.

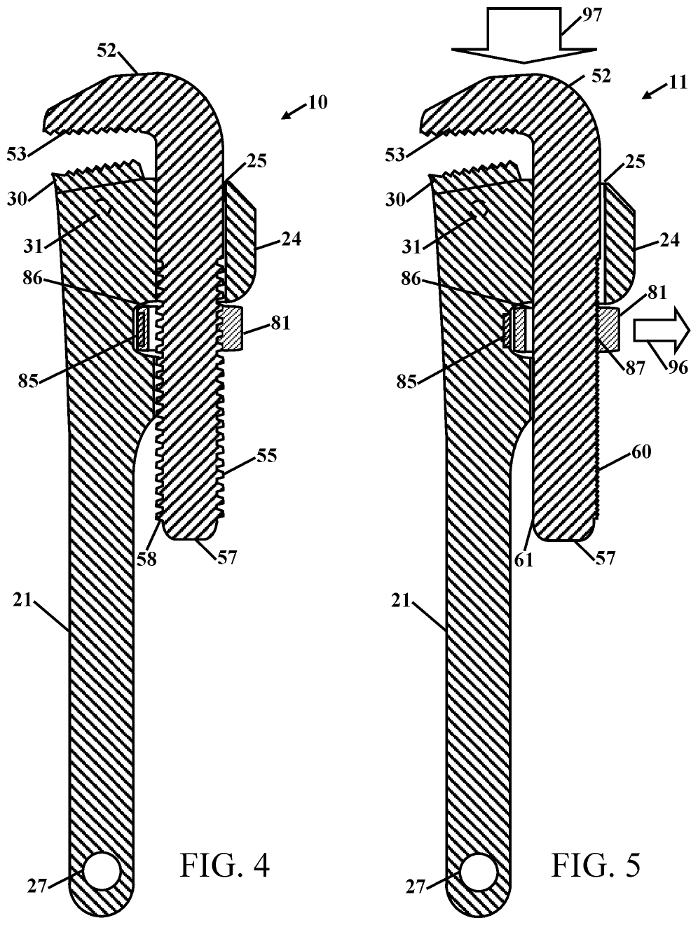

FIG. 4 shows a cross-sectional view of a preferred embodiment of the adjustable wrench 10 and FIG. 5 shows a cross-sectional view of a second preferred embodiment of the adjustable wrench 11. These cross-sections show embodiments with the magnet 85 in the slide body 81, in FIG. 4 and in the handle 21 of the fixed body, in FIG. 5. The opening 25 at the top back of the handle 21 shows the slide 51, below the head 52 of the upper jaw 53. At the bottom 57 of slide 51 is rounded or squared and slide 51 can be completely unscrewed from the bottom 57 of the teeth 55 to remove or replace the slide 51.

In some embodiments the bottom of the wrench body handle 21 can have a handle opening 27 or hole for hanging the wrench 10. Also, in some embodiments the lower jaw 30 can be replaceable by removing the pin 31 to change the teeth 32 or to use a jaw that is smooth.

The quick adjust wrench has a wrench body 24 with a fixed lower jaw 30. The wrench body 24 has an opening 25 whereby an upper jaw 53 on a slide 51 is configured to pass therethrough. A gap 86 allows for clearance of the slide body in the wrench 10 handle 21. Slide 51 is configured with a plurality of teeth 55/58 on at least one side of slide 51. There is slide keeper 80 that has a mating plurality of teeth 87 that are configured to temporally engage on the teeth 55/58 on said slide 51. The slide 51 is configured with a magnet 85 to continuously bias the slide keeper 80 toward the wrench body 21 to engage the teeth 87 with the teeth 55. The teeth 87 may only exist on one inside wall of the slide keeper 80. The slide keeper 80 is configured to slide out 96 from the wrench body 21 to disengage the teeth 87 from the teeth 55, whereby allowing the slide 51 to freely move up or down 97 within said opening 25. In various configurations magnet 85 can be in the body 21 of the fixed portion of the wrench, in the slide keeper 80 or in both locations.

It is also contemplated that the teeth 55/87 can be configured as saw tooth teeth 60 whereby the movable jaw 53 with the slide 51 can be pushed down 97 into the fixed body 21 and the ramped configuration of the saw teeth can overcome the magnetic attraction, but the magnetic attraction prevents the teeth 55/87 from disengaging from forces between the fixed lower jaw 30 and the upper jaw 53 when the wrench 10 is being used.

Thus, specific embodiments of a quick adjust wrench have been disclosed. It should be apparent, however, to those skilled in the art that many more modifications besides those described are possible without departing from the inventive concepts herein. The inventive subject matter, therefore, is not to be restricted except in the spirit of the appended claims.

1: A quick adjust wrench comprising:
a wrench body having a lower jaw;
said wrench body having an opening whereby an upper jaw on a slide is configured to pass therethrough;
said slide is configured with a plurality of teeth;
a slide keeper having a mating plurality of teeth that are configured to temporally engage on said plurality of teeth on said slide;
said slide is configured with a magnet to continuously bias said slide keeper toward said wrench body to engage said teeth, and
said slide keeper is configured to slide from said wrench body to disengage said plurality of teeth whereby allowing said slide to freely move within said opening.

2: The quick adjust wrench according to claim 1, wherein said magnet is secured in said slide keeper.

3: The quick adjust wrench according to claim 2, wherein a second magnet is secured in said wrench body.

4: The quick adjust wrench according to claim 1, wherein said magnet is secured in said wrench body.

5: The quick adjust wrench according to claim 1, wherein said plurality of teeth are sawtooth shaped.

6: The quick adjust wrench according to claim 1, wherein said plurality of teeth are square shaped.

7: The quick adjust wrench according to claim 1, wherein said plurality of teeth are ACME shaped.

8: The quick adjust wrench according to claim 1, wherein said slide keeper has at least one side grip.

9: The quick adjust wrench according to claim 2, wherein said slide keeper is configured to replace an existing nut on a pipe wrench.

10: The quick adjust wrench according to claim 1, wherein said quick adjust wrench is a pipe wrench.

11: The quick adjust wrench according to claim 2, wherein said wrench body is a ferric material.

12: The quick adjust wrench according to claim 1, wherein said slide keeper is a ferric material.

13: The quick adjust wrench according to claim 1, wherein said lower jaw is replaceable.

14: The quick adjust wrench according to claim 13, wherein lower jaw is retained in said wrench body with a pin.

15: The quick adjust wrench according to claim 1, wherein said plurality of teeth are angled.

16: The quick adjust wrench according to claim 1, wherein said plurality of teeth are on only one inside wall of said slider keeper.

17: The quick adjust wrench according to claim 1, wherein a distance between said lower jaw and said upper jaw is configurable to accept a pipe or a nut therein between.

18: The quick adjust wrench according to claim 1, wherein said upper jaw is configured to be completely removed from said wrench body.

19: The quick adjust wrench according to claim 1, wherein said wrench body is configured as an elongated handle.

20: The quick adjust wrench according to claim 19, wherein said elongated handle further includes a handle opening.
